(19) United States
(12) Patent Application Publication
(10) Pub. No.: US 2018/0367861 A1
(43) Pub. Date: Dec. 20, 2018

(54) TEMPORAL GENERATION OF CONTENT PLAYLISTS

(71) Applicant: Sony Interactive Entertainment LLC, SAN MATEO, CA (US)

(72) Inventors: Bhumik Sanghavi, Emeryville, CA (US); Mani Kishore Chitrala, Union City, CA (US); Alex Hwang, Orinda, CA (US)

(21) Appl. No.: 15/624,514

(22) Filed: Jun. 15, 2017

(51) Int. Cl. H04N 21/482; H04N 21/2187; H04N 21/458; H04N 21/45; H04N 21/278; G06F 17/30

(52) U.S. Cl. CPC H04N 21/4825; H04N 21/2187; H04N 21/458; G06F 17/3082; H04N 21/278; G06F 17/3084; G06F 17/30849; H04N 21/4532

(57) ABSTRACT

The present disclosure describes methods and systems directed towards temporal generation of content playlists. The generated playlists (i.e. binge watching playlist) facilitates a user to view a variety of different types of live content (i.e. live television) in an automated fashion that resembles binge watching as implemented via DVD or streaming content. This allows content to be provided in succession during the span of time (i.e. binge watching session) without the user needing to search for or request the next content to be displayed on the user device.

### BACKGROUND

### Field of Invention

The present invention generally relates to content playlists. More specifically, the present invention relates to temporal generation of content playlists.

### Description of the Related Art

Binge watching refers to the practice of watching multiple shows in rapid succession over a span of time (i.e. binge watching session). This is generally done via DVDs or digital streaming where successive content in a pre-determined order (such as the next episode in the series) is provided to the viewer upon completion of a current show. The content being viewed may include episodes of a television program or series. In this way, the viewer can watch multiple episodes in succession without having to go out and find the next episode or wait for the next episode to air (e.g. if the show typically only airs once a week).

There does not exist ways for users to easily or seamlessly binge watch different live content. In particular, there does not exist ways for viewers to binge watch content on different channels or content that belong to different programs or series. In each of these cases, the user would need to manually locate, record, and/or search for the content that belongs to different programs or series. For live content, the user would need to schedule their viewing time around when the live content becomes available or program the recording of the live content for later viewing. Even after doing all these steps to obtain the content for viewing, the different content that the user may have lined up to watch would not be automatically provided to the user in succession (e.g. a collection of live content, recorded content, content on demand) thereby preventing the user from easily or seamlessly binge watching content on their user device.

### SUMMARY OF THE CLAIMED INVENTION

Embodiments of the present invention include systems and methods for temporal generation of content playlists. The embodiments receive information regarding live content coming from different sources. Using the information, a database (i.e. guide) is generated that compiles the information into a format that is displayed on user devices. The users are able to view information associated with the live content and schedule when they would like to view the live content. A playlist that includes all the selected live content that the user would like to view as well as when the user would like to view the live content is generated. The playlist facilitates automatically providing the scheduled live content to the user device in a successive manner so that users can view all the content during a binge watching session. In this way, the user would not need to manually search for or request live content during the binge watching session thereby allowing the rapid viewing of content back to back.

Embodiments of the present invention also include systems and methods for providing the live content to a user based on the temporally generated content playlists. By using a generated playlist, the scheduled live content on the playlist can be obtained from the different content sources and automatically provided in a successive order for the user to view on the user device. Once viewing of a current live content has been completed, a next scheduled live content can be provided without the user needing to search for or request the next live content.

### BRIEF DESCRIPTION OF THE DRAWINGS

FIG. 1 is a system for binge watching playlists.

FIG. 2 is a user device used in context of the binge watching playlist of FIG. 1.

FIG. 3 illustrates a method for generating binge watching playlists for the user.

FIG. 4 illustrates a method for providing content for the user to view based on the generated binge watching playlists.

FIG. 5 is a guide that users can use to generate their binge watching playlist.

FIG. 6 is a binge watching playlist generated using the guide of FIG. 5.

### DETAILED DESCRIPTION

The present disclosure describes methods and systems directed towards temporal generation of content playlists. In particular, the generated playlists ((hereinafter referred to as a binge watching playlist) automatically displays content for a user to view during a span of time (i.e. binge watching session). For example, the binge watching playlist facilitates a user in viewing a variety of different types of live content (i.e. live television) in an automated fashion that resembles binge watching as implemented via DVD or streaming content. This allows the live content to be provided in succession without the user needing to search for or request the next live content to be displayed on the user device.

Once the binge watching playlist is generated, the playlist can be used to facilitate the user in watching multiple different content during a binge watching session at a time desired (e.g. scheduled) by the user. As noted above, the generated binge watching playlist would facilitate the automated and seamless transitions between different live content for the user. The transitions may be performed by the binge watching playlist system via retrieving the live content as the live content is initially aired from its respective source and providing the live content to the user once a current live content has been viewed in accordance to the binge watching playlist. Alternatively, the binge watching playlist may temporarily record and store the live content until the scheduled viewing time of the content by the user as dictated by the binge watching playlist. By using the binge watching playlist, users would not need to manually perform any operations to search for, request, and retrieve the next live content in a viewing queue during a binge watching session. Rather, the scheduling and the retrieval of content that will be viewed by the user during the binge watching session would be automated and seamless based on the generated binge watching playlist.

It should be noted that alongside live content, content on demand (e.g. movies, online content) can also be incorporated with the binge watching playlist. The binge watching playlist system would operate in a similar manner with respect to the content on demand. The binge watching playlist would be used to seamlessly search for and provide the corresponding content on demand based on the binge watching playlist. In this way, the binge watching playlist may include live content, content on demand, as well as a combination of the two.

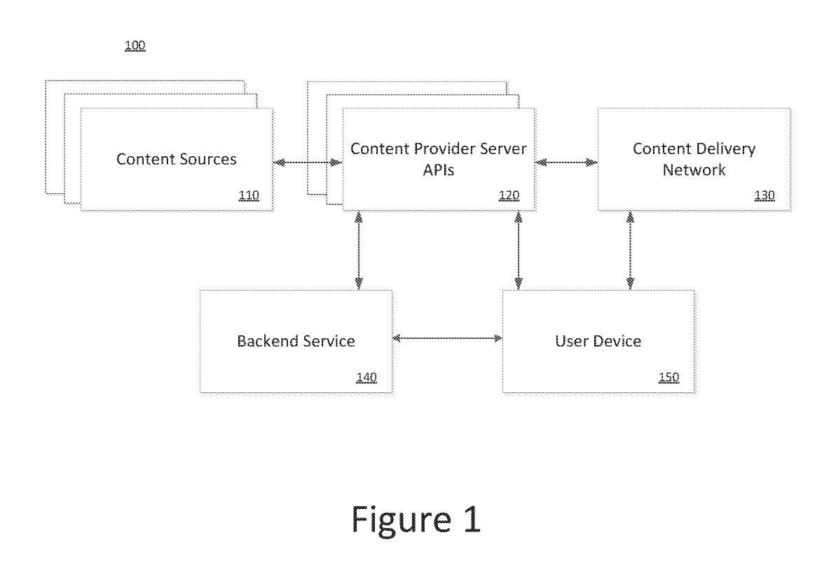

FIG. 1 is a system 100 for binge watching playlists. In particular, the system 100 facilitates the generation of the binge watching playlists and utilizing the binge watching playlists to carry out the binge watching session for the user. As illustrated in FIG. 1, the binge watching playlist system 100 includes a plurality of different elements that collectively work together in order to provide the ability to generate and carry out the binge watching playlists for each user on their respective user device 150.

The binge watching playlist system 100 obtains content (e.g. video content) from a variety of different content sources 110. For example, the binge watching playlist system 100 accesses information related to live content (i.e. live television) from each of their respective content sources 110. Such information includes future scheduling for all live content for a predetermined period of time (e.g. seven days in advance) although different periods of time may be available based on the difference sources. By using the future schedule for the live content from the content sources 110, users are able to utilize the binge watching playlist system 100 (via their user device 150) in order to schedule when to view the live content within their binge watching playlist. This future schedule may be populated within a guide that allows users to select what live content the user would like to view during a binge watching session. Alternatively, the schedule associated with the binge watching playlist can also be used to control when associated digital video recording (DVR) devices (not shown) record the live content when the live content airs for viewing by the user at a later time.

In some embodiments, the future schedule for live content can also be provided by third party entities that collect and compile scheduling information for all live content for a predetermined period of time. The binge watching playlist system 100 may also be capable of obtaining related future schedule from such third party entities. Information from third party entities regarding live content may be compiled with the future schedule from the content sources 110.

Additional information from the content sources 110 may also include details about the live content being provided from each of the content sources 110. For example, each type of live content (e.g. television program) may include (or at least be assigned) a unique identification that is used to identify related content for the binge watching playlist system 100 being retrieved from the content source 110. Further identification information may be provided to the binge watching playlist system 100 to identify a particular episode or portion of the live content being retrieved from the content source 110.

Information from the content source 110 may also include details specific to the live content that can be provided to the binge watching playlist system 100. The specific information about the live content can be displayed for the user to identify and inform what the live content may be about. For example, such specific details may include information such as run time for the live content, the date and time of when the live content first aired, parental ratings (i.e. E, G, PG+13, R) for viewing the live content, overview of the live content, and any requirements or credentials (e.g. license, subscription, account sign-in, platform) needed to view the live content.

In some embodiments, content on demand (such as movies) may also be incorporated in the binge watching playlist system 100. The content on demand may be treated in a similar manner as the live content. For example, each of the content on demand would have their own respective content sources 110 similar to the live content described above. The content on demand may similarly be described using unique identification for the content as well as include specific details about the content. However, whereas the live content would require the user to wait until at least when the live content airs publicly for the first time, the content on demand may be viewable via the binge watching playlist system 100 at any time by the user.

In a further embodiment, the binge watching playlist system 100 can also access third party video content from various third party content providers (e.g., Twitch, Youtube). Similar to content on demand, content from various third party content providers may be scheduled and viewed using the binge watching playlist system 100.

A Content Provider Server API (Application Program Interface) 120 provides instructions usable by the user device 150 associated with the binge watching playlist system 100 regarding how to access content (e.g., streaming media, video on demand, third party content, live content) from the different content sources 110. Each of the content sources 110 may have their own respective content provider server API 120 that includes their unique set of instructions to facilitate the user device 150 in accessing their content. In some embodiments, Content Provider Server APIs 120 may be shared between two or more different content sources 110 in situations where requirements or instructions for the user device 150 for access of their associated content are similar or identical. In particular, the Content Provider Server API 120 would be responsible for processing/ingesting the content from the content sources 110 so that the content is compatible with the user device 150. Furthermore, corresponding encoding and decoding instructions can be included as well.

The Content Provider Server API 120 also allows the user device 150 to access additional information about the content (e.g. live). Such additional information may include metadata (e.g., author, title, genre) describing the live content. The additional information may also include a location where the content is currently stored (e.g., URL) so that the client device 150 can proceed with retrieving the content from the appropriate content source 110. The Content Provider Server API 120 can also include instructions for implementing features such as a chat interface that would allow different users simultaneously viewing the same content to interact with each other in real time.

In some embodiments such information can be provided to the user (at the user device) through the processing of electronic program guide (EPG) feeds provided from third parties. The Content Provider Server API 120 is able to collect and process the EPG feeds so that the information contained within the feeds is provided to the user at the user device in a compatible format such as a guide.

The Content Provider Server API 120 performs processes to have the content available and compatible (for example via formatting) with the user device 150 of the user. For example, the Content Provider Server API 120 may carry out instructions that would identify content formats and subsequently format the content from the different content sources 110 so that the formatted content is usable by the user device 150. The instructions may include extracting metadata associated with each of the content and subsequently using various different types of conversion techniques so that the content stored in one format with respect to the content sources 110 can be rendered and displayed on the user devices 150, which may correspond to a second format. Once the content obtained from the content source 110 has been processed by the Content Provider Server API 120, it is then stored in the Content Delivery Network 130 for viewing by the user on the user device 150 upon request.

The Content Provider Server API 120 is also capable of implementing additional functionalities associated with the various content sources 110. For example, information regarding chat services, ratings and profiles can be provided from the content sources 110 to the user device 150 via the Content Provider Server API 120. The Content Provider Server API 120would carry out the instructions from the content sources 110 in order to implement the information related to chat services, ratings and profiles so that the information appears on the user device 150.

As noted above, content on demand would also be available for the users to view on their user device 150 alongside live content. The Content Provider Server API 120 would receive metadata associated with the content on demand that can be provided to the user upon request. Furthermore, the Content Provider Server API 120 would facilitate in the providing of the content on demand to the Content Delivery Network 130 upon request by the user associated with the binge watching playlist.

Aside from storing the processed content from the content sources 110, the Content Delivery Network 130 also includes a server that provides static resources used by the binge watching playlist system 100. For example, static resources may include various files that are usable by the binge watching playlist system 100 in order to provide information to the user device 150 when the user device 150 is not yet subscribed to the binge watching playlist system 100. Such static information may include promotional images (e.g. thumbnails) and service configurations with the user devices 150 that are not yet subscribed to the binge watching playlist system 100.

It should be noted that subscriptions may or may not be needed with respect to different features of the binge watching playlist system 100. In some embodiments, subscriptions may include a periodic payment from the user in order to access services associated with the binge watching playlist system 100. In other embodiments, subscriptions may not require payment but may instead require an authenticated user account associated with the binge watching playlist system 100. In a further embodiment, users may be provided different sets of features and benefits based on the type of subscription they possess. For example, having an authenticated user account may provide a first set of benefits such as being able to generate a binge watching list that includes three different types of content while payment of a subscription fee may provide a second set of benefits such as access to unique content in addition to the first set of benefits. There may be embodiments where there are different types of subscription fees (e.g., silver, gold level subscriptions) and different benefits associated with payment of the different type of subscription fees.

The Content Delivery Network 130 can also be called upon by the user devices 150 when requesting to view specific content associated with the binge watching playlist. For example, once a binge watching playlist has been generated, the binge watching playlist information is provided to the Content Delivery Network 130 so that the corresponding content can be provided for the user to view on the user device 150. For example, content that would be viewed by the user at a particular time (e.g. the user schedules to view show A at 9:00 PM), would be requested from the Content Delivery Network 130 by the user device 150 using the binge watching playlist. The scheduled content is then provided to the user device 150 to be displayed at the user device 150 based on the schedule set forth in the binge watching playlist.

The Content Provider Server API 120 can also be accessed by a backend service layer 140. As illustrated in the figure, the binge watching playlist system 100 includes the back end service 140 that facilitates carrying out the binge watching playlist for the client device 150. In particular, the backend service 140 is responsible for communicating with the Content Provider Server APIs 120 regarding what available content the user is able to view on the user device 150. For example, some content may require the purchase of a subscription to the corresponding content source such as a channel or purchase of a license to a particular content in order to view. Other content may be restricted for user viewing based on characteristics of the user such as location or age.

The backend service 140 would keep track of the user characteristics and restrictions associated with the content. Based on what content the user wishes to view using the binge watching playlist, backend service 140 can then subsequently communicate with the Content Provider Server API 120 to make the requested content available presuming that no restrictions are present.

If the user requests content that is restricted, the backend service 140 may provide a notification to the user device 150 informing the user that such content may not be currently viewed at the user device 150. In some embodiments, the backend service 140 may provide information regarding how the user may gain access to the restricted content. For example, such information may include a transaction where payment of a subscription or license fee would allow the user to view the information. The backend service 140 may also provide alternative ways for the user to view the content if currently unavailable via the binge watching playlist system.

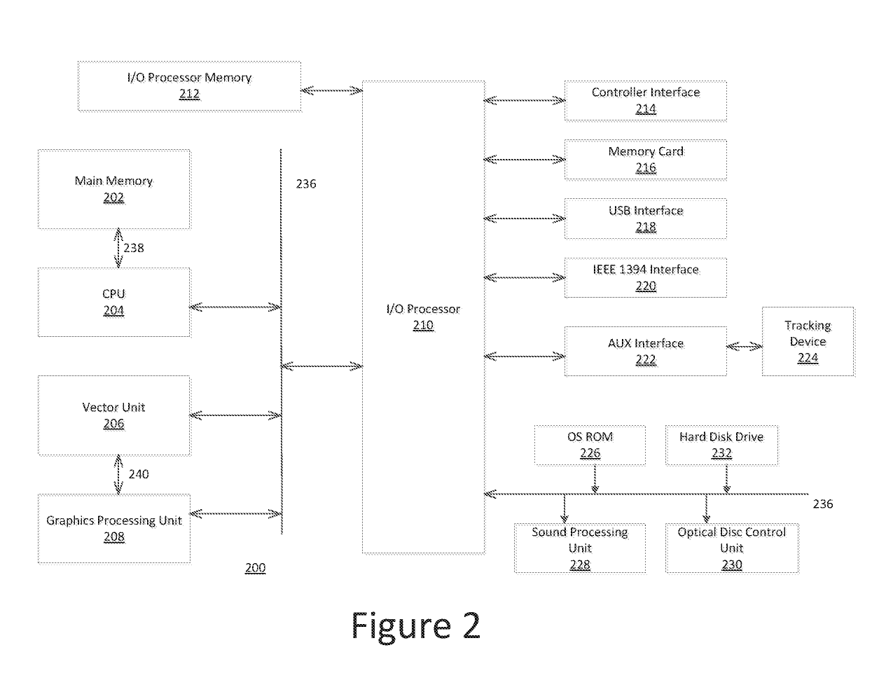

The binge watching playlist system 100 is compatible with any number of different user devices 150. The user device 150 can include a plurality of different computing devices. For example, the client device 150 may include any number of different gaming consoles, mobile devices, laptops, and desktops. These client devices 150 may also run using a variety of different operating systems (e.g., iOS, ANDROID), applications, third party devices (e.g. APPLE TV, ROKU, FIRETV) or computing languages (e.g., C++, JAVASCRIPT). The binge watching playlist system 100 may facilitate communication between similar types of user devices 150 as well as between different types of user devices 150, for example, via sharing of binge watching playlists or implementing chat functionality associated with content viewing. Details regarding exemplary user devices 150 are provided below with respect to FIG. 2.

Each of the user devices 150 may already know how to perform various processes used to schedule, retrieve, format, and display the content for the user to view as described herein using various applications or instructions run on the user device 150. In some embodiments, the binge watching playlist system 100 may provide the necessary instructions (via downloadable updates) that can be used by the user devices 150 to carry out the various processes used to schedule, retrieve, format, and display the content for the user to view as described herein. In another embodiment, the user devices 150 may also be able to download (or in some other way receive) an application that includes the necessary instructions to schedule, retrieve, format, and display the content. Execution of the application would allow the user device 150 to carry out the scheduling, retrieval, formatting, and displaying of the content as described herein.

FIG. 2 is a user device 200 used in context of the binge watching playlist of FIG. 1. The user device 200 (e.g., desktop, laptop, tablet, mobile device, console gaming system) is a device that the user can utilize to facilitate carrying out features of the present invention pertaining to the binge watching playlist. In particular, the user device 200 allows the user to schedule what content and when the content would be viewed via the binge watching playlist. The user device 200 would also facilitate the user viewing of the content via a display associated with the user device 200.

The user device 200 may include various elements as illustrated in FIG. 2. It should be noted that the elements are exemplary and that other embodiments may incorporate more or less than the elements illustrated. With reference to FIG. 2, the user device 200 includes a main memory 202, a central processing unit (CPU) 204, at least one vector unit 206, a graphics processing unit 208, an input/output (I/O) processor 210, an I/O processor memory 212, a controller interface 214, a memory card 216, a Universal Serial Bus (USB) interface 218, and an IEEE 1394 interface 220, an auxiliary (AUX) interface 222 for connecting a tracking device 224, although other bus standards and interfaces may be utilized. The user device 200 further includes an operating system read-only memory (OS ROM) 226, a sound processing unit 228, an optical disc control unit 230, and a hard disc drive 232, which are connected via a bus 234 to the I/O processor 210. The user device 200 further includes at least one tracking device 224.

The tracking device 224 may be a camera, which includes eye-tracking capabilities. The camera may be integrated into or attached as a peripheral device to user device 200. In typical eye-tracking devices, infrared non-collimated light is reflected from the eye and sensed by a camera or optical sensor. The information is then analyzed to extract eye rotation from changes in reflections. Camera-based trackers focus on one or both eyes and record their movement as the viewer looks at some type of stimulus. Camera-based eye trackers use the center of the pupil and light to create corneal reflections (CRs). The vector between the pupil center and the CR can be used to compute the point of regard on surface or the gaze direction. A simple calibration procedure of the viewer is usually needed before using the eye tracker.

Alternatively, more sensitive trackers use reflections from the front of the cornea and that back of the lens of the eye as features to track over time. Even more sensitive trackers image features from inside the eye, including retinal blood vessels, and follow these features as the eye rotates.

Most eye tracking devices use a sampling rate of at least 30 Hz, although 50/60 Hz is most common. Some tracking devises run as high as 1250 Hz, which is needed to capture detail of very rapid eye movement.

A range camera may instead be used with the present invention to capture gestures made by the user and is capable of facial recognition. A range camera is typically used to capture and interpret specific gestures, which allows a hands-free control of an entertainment system. This technology may use an infrared projector, a camera, a depth sensor, and a microchip to track the movement of objects and individuals in three dimensions. This user device may also employ a variant of image-based three-dimensional reconstruction.

The tracking device 224 may include a microphone integrated into or attached as a peripheral device to user device 200 that captures voice data. The microphone may conduct acoustic source localization and/or ambient noise suppression. The microphones may be usable to receive verbal instructions from the user to schedule, retrieve and display content on the user device 200.

Alternatively, tracking device 224 may be the controller of the user device 200. The controller may use a combination of built-in accelerometers and infrared detection to sense its position in 3D space when pointed at the LEDs in a sensor nearby, attached to, or integrated into the console of the entertainment system. This design allows users to control functionalities of the user device 200 with physical gestures as well as button-presses. The controller connects to the user device 200 using wireless technology that allows data exchange over short distances (e.g., 30 feet). The controller may additionally include a “rumble” feature (i.e., a shaking of the controller during certain points in the game) and/or an internal speaker.

The controller may additionally or alternatively be designed to capture biometric readings using sensors in the remote to record data including, for example, skin moisture, heart rhythm, and muscle movement.

As noted above, the user device 200 may be an electronic gaming console. Alternatively, the user device 200 may be implemented as a general-purpose computer, a set-top box, or a hand-held gaming device. Further, similar user devices may contain more or less operating components.

The CPU 204, the vector unit 206, the graphics processing unit 208, and the I/O processor 210 communicate via a system bus 236. Further, the CPU 204 communicates with the main memory 202 via a dedicated bus 238, while the vector unit 206 and the graphics processing unit 208 may communicate through a dedicated bus 240. The CPU 204 executes programs stored in the OS ROM 226 and the main memory 202. The main memory 202 may contain pre-stored programs and programs transferred through the I/O Processor 210 from a CD-ROM, DVD-ROM, or other optical disc (not shown) using the optical disc control unit 232. The I/O processor 210 primarily controls data exchanges between the various devices of the user device 200 including the CPU 204, the vector unit 206, the graphics processing unit 208, and the controller interface 214.

The graphics processing unit 208 executes graphics instructions received from the CPU 204 and the vector unit 206 to produce images for display on a display device (not shown). For example, the vector unit 206 may transform objects from three-dimensional coordinates to two-dimensional coordinates, and send the two-dimensional coordinates to the graphics processing unit 208. Furthermore, the sound processing unit 230 executes instructions to produce sound signals that are outputted to an audio device such as speakers (not shown).

A user of the user device 200 provides instructions via the controller interface 214 to the CPU 204. For example, the user may instruct the CPU 204 to store certain information on the memory card 216 or instruct the user device 200 to perform some specified action. Example controllers associated with the controller interface 214 may include a touch-screen, keyboards and game controllers.

Other devices may be connected to the user device 200 via the USB interface 218, the IEEE 1394 interface 220, and the AUX interface 222. Specifically, a tracking device 224, including a camera or a sensor may be connected to the user device having the first party portal 200 via the AUX interface 222, while a controller may be connected via the USB interface 218.

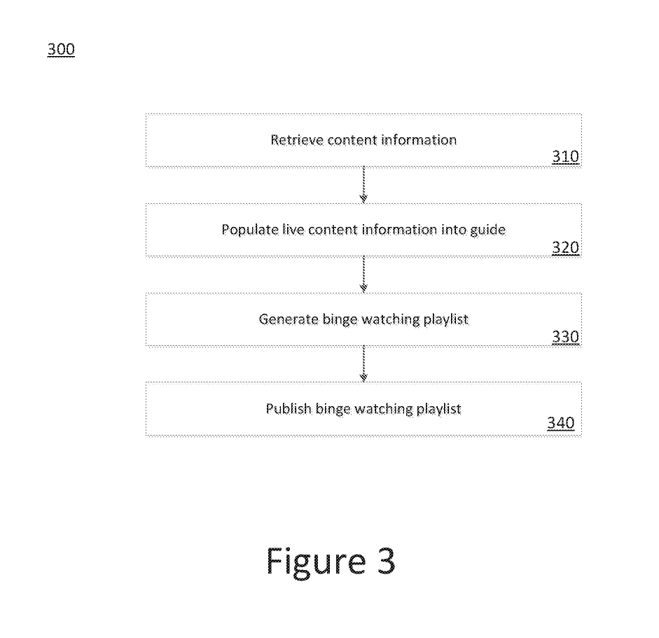

FIG. 3 illustrates a method 300 for generating binge watching playlists for the user. As described above, the binge watching playlist allows users to view multiple different content in an easy and seamless manner by automatically retrieving subsequent content after a current content has been completed without the need for the user to search for and request for the subsequent content. The binge watching playlist may include a plurality of different content provided from different sources. As noted above, the content may include live content and/or content on demand from their respective content sources.

In step 310, content information is retrieved. The user may be able to identify (i.e. select) what content the user is interested in viewing. For example, the user may identify specific live content from their corresponding content sources. In some cases, the user may establish a user profile that has included selected live content or content sources the user prefers. The user profile can be used to automatically identify what content information will be retrieved.

The content information associated with live content may include scheduling information dictating when the live content would be aired. This may be represented via an initial time period when the live content can be viewed for the first time. In some cases, the live content information may be provided from each content source that provides the live content. In other cases, third parties may provide this live content information. All the live content information regarding scheduling can be collected at a server or the user device and be compiled into a single data set. This data set would resemble a guide that provides information that would allow the user to figure out what content is available and when to schedule the viewing of the content within their binge watching playlist.

The guide that is compiled for the user would include information about what live content is available from which source and at what time. Additional information specific to each content such as summary of content, synopsis of episode, rating, and run-time can also be provided for informing the user and scheduling purposes. The guide would then be used by the user via the user device in order to schedule what content would be viewed via the binge watching playlist. In this way, the user can schedule content (e.g. live content) from multiple different sources to be viewed during a binge watching session.

The guide can be presented using a customized user interface that allows users to interact with different elements that correspond to a particular piece of content. Selection of an element can indicate a user's desire to schedule that corresponding live content into the binge watching playlist. The user can then be requested when (i.e. date and time) the live content would be viewed. In some cases, the user can provide a time period of when the user would like to have a binge watching session and the selected live content could be scheduled within that time period automatically.

It should be noted that the user interface may also be capable of providing a notification that the live content would not be available if the user attempts to schedule viewing of live content before the actual live air date and time of the live content (i.e. the user can't view live content before it is actually available). In this case, the notification may provide information as to when the live content may be viewable or may suggest other content that can be viewed in its place.

There may be situations, however, that specific users are allowed early viewing of live content based on special conditions (i.e. subscription). These special conditions can be implemented by the binge watching playlist system to allow user access to the live content accordingly if such conditions are applicable with the corresponding content source. The user interface associated with the guide may be able to receive authentication of such special conditions from the user in order to allow the scheduling of live content for an early viewing.

The Content Provider Server API of FIG. 2 may provide the scheduling information regarding content to the user device. Alternatively, the scheduling information may also be provided to the Content Provider Server API (to be compiled with information from the content sources) from various third party entities. For content on demand, a separate guide may be provided separate from the live content since the content on demand is already available. Information about each content on demand may be provided via metadata to the Content Provider Server API 120 so that information about the content on demand can be used by the user to schedule such content within the binge watching playlist. Furthermore additional information about the content on demand may also be available for viewing on the guide for the content on demand.

Selection of a particular content (live or content on demand) from their respective guide can bring up a new window that provides information specific to that content. For example information about the rating, overview, run-time, and credentials of the content can be displayed for the user to view on their user device.

Information associated with content may be continually updated based on what information is available for that content. For example, information associated with future scheduling of live content may be available for a pre-determined period of time into the future; a content source may publicly provide information regarding what live programming will be provided for the next seven days. The different sources or third party entities compiling the information may provide different periods of time regarding when live content will be available.

Aside from when future live programming will be available, the information retrieved from the content sources may also include information specific to the live content as well. This information can include summary of an overall series, a synopsis of a particular episode, ratings, run-time, and credentials/restrictions associated with viewing the live content. This information may become available as the actual date nears the air date for the live content. For example, such information may become available two to three days beforehand.

Information for available content on demand (e.g. movies) can also be obtained from different content sources. Similar to the identification of what live content the user would like to view, the user can also identify what available content on demand the user would like to view as well. The user can also filter what content can be retrieved from already existing content on demand. For example, the user can identify a particular genre, actor, or year associated with content that the user may be interested to view. Information for available content on demand can then be retrieved from content sources based on the filtered search.

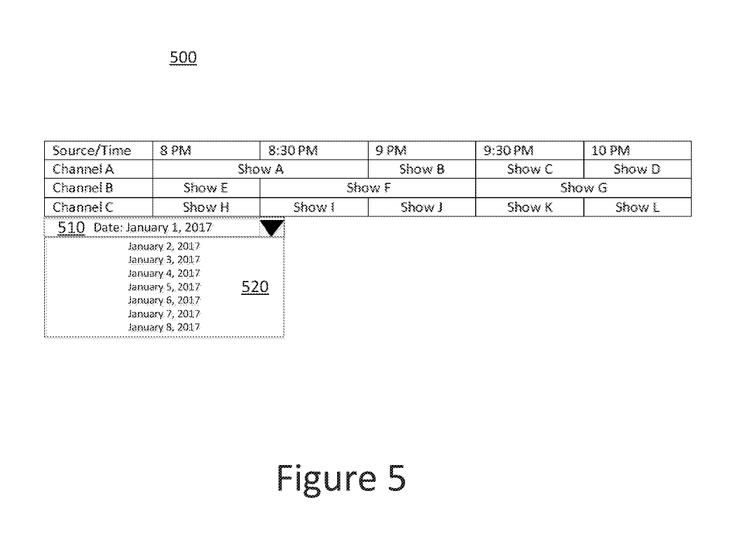

In step 320, the retrieved content information is populated into a guide. An example guide for live content is illustrated in FIG. 5 although other ways of displaying the retrieved content information may also be possible. The guide may be a customizable user interface that populates all the retrieved content information into a searchable format that would be used by the user to schedule what content will be viewed via the binge watching playlist. For example, the guide may identify what content sources are currently being selected by the user along with the upcoming live content scheduled for the upcoming future time period. By using the guide, the user can select what upcoming live content should be placed and scheduled in the binge watching playlist.

With respect to content on demand, the content sources may provide a list of what content (e.g. movies) may be currently available with respect to each content source. The content within each content source may be sorted, for example, by genre. The user can select each content source (e.g. channel/station) and view what content on demand is currently available. Using the list, the user can then proceed with scheduling the content on demand within the binge watching playlist.

In the guide, each content source can identify when live content will be available on a particular day and at a particular time. For example, show A will air on Monday at 9 PM. The live content (i.e. show A) will be associated with a unique identification information corresponding to the overall live content series. Furthermore, the live content may also be associated with further identification corresponding to a particular episode. These sets of information may be used to later search for live content after it has aired.

The additional information about the live content such as the overview of the content, rating, run time, and credentials can also be included in the guide associated with the corresponding live content. For example, upon user selection of a particular live content entry within the guide, the guide may populate an additional window with the additional information for the user to view on the user device. The user can then view the additional information prior to deciding on whether to schedule the live content into the binge watching playlist.

Similarly, the list of content on demand compiled from each content source can also be used to inform the user what content on demand is currently available. For example, a content source may include multiple movies within a particular genre or from a particular movie studio. The list include these available movies with the additional information that users can view to learn more about a particular movie (e.g. summary, run time, rating, and credentials) upon selection of the movie.

When the user selects one or more of the entries within the guide or list, the user may be provided a prompt related to scheduling the viewing of the selected live content into a binge watching playlist associated with the user. The user may dictate on what day and at what time the user would like to view the content. Once confirmed, information about the selected live content can be associated with the user's binge watching playlist.

In another embodiment, the user may be able to dictate a period of time when a binge watching session would be performed. For example, the user may wish to plan for a binge watching session for the upcoming weekend between 1 PM and 6 PM. Upon selection of content to be scheduled with the binge watching playlist, it may be possible that the binge watching playlist system automatically schedules the selected content within the period of time. Based on the presence of other content stored within the binge watching list, the scheduling of subsequent content may also be modified so that the content can be viewed seamlessly. For example, there may be priority given to live content to be viewed at the time of airing if such content is scheduled during a binge watching session. The scheduling of other live content or content on demand may be based around content that is currently live during the binge watching session.

In another embodiment, the user may just need to dictate an order that the user would like to view the content in the binge watching playlist. When a binge watching session commences, the order would dictate to the binge watching playlist system what content should be retrieved and provided to the user on the user device to view. The order would then dictate what subsequent content should be retrieved and provided to the user device. If the binge watching list still has content on the list after a binge watching session has ended, the content on the list may be maintained until the next binge watching session.

In some situations where some content (i.e. live content) has one or more restrictions, the guide or list may provide information related to the restriction and how to resolve the issue. For example, if the content requires a membership or user account, the guide may include instructions that can be forwarded to the user device that requests the user to sign up for an account associated with the content source or sign into an authorized account. Once the user has signed into an authorized account, the selected content can be scheduled into the binge watching playlist.

In another example, if the content requires a subscription or license to view, the guide may include instructions that can be forwarded to the user device that requests user payment or other transactional processes in order to allow access to the content. Once the user has fulfilled payment associated with the required subscription or license to view the content, the user can schedule the selected content into their binge watching playlist.

In another situation, if the content is restricted for various reasons, such as via a blackout for local sports games, the guide may include information that can be forwarded to the user device that provides alternative content sources that may allow viewing of the same content. The guide may inform the user of other content providers that may provide the same content that may be scheduled within the binge watching playlist. However, there may be additional requirements (i.e. user account, subscription) associated with viewing the same content from another content source.

In another embodiment, alternative suggested content (e.g. such as other content within a related genre) can be provided to the user if for some reason the user is not able to view the originally selected content for any of the reasons listed above. The user can be provided alternative content from other sources that may be scheduled into the binge watching playlist.

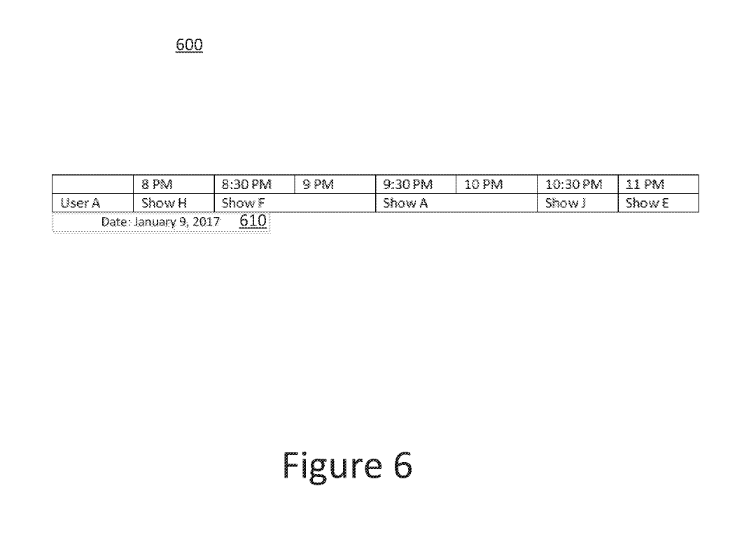

In step 330, the binge watching playlist is generated using the guide. In an embodiment, the binge watching playlist is generated through user selection of the live content in the guide generated in step 320. As noted above, the user is able to select what live content the user would like to view and schedule it within the binge watching playlist as to when the live content should be viewed. An example binge watching playlist is provided in FIG. 6 although other embodiments for implementing the binge watching playlist are also possible.

Similarly, the binge watching playlist can be generated via selection of content on demand from a list. The list may be associated with each content source and provides what content on demand is available. By selecting a particular content on demand that the user would like to view, such content can be scheduled within the binge watching playlist similar to the live content described above.

In step 340, the generated binge watching playlist can be published. Once the binge watching playlist has been published, this allows the binge watching playlist to utilize the playlist to retrieve and provide the listed content for the user at the user device during a binge watching session.

Furthermore, once the binge watching playlist has been published, the binge watch playlist can shared with other users. In this way, a first user can share what they intend to view with other users who may share similar interests. The other users can choose to view the content alongside the first user based on the schedule according to the generated binge watch playlist. In other embodiments, the other users may also utilize the first user's binge watching playlist to schedule content to be viewed in their own binge watch playlists.

The other users may interact with the first user's generated binge watch playlists in a similar manner as how users can interact with the guide described above in step 320. The other users may select the scheduled content within the generated binge watching playlist in order to obtain additional information about the content (i.e. summary, run time, rating, and credentials) in deciding whether to view and/or schedule that content.

Similar to when the user was generating the binge watching playlist through the selection of content from different sources, restrictions (i.e. user account, subscription, blackout) may also prevent the other users from accessing the content in the first user's binge watching playlist. If the other users are able to overcome or address the restrictions (i.e. signing into an authorized user account, payment for the subscription), the other users would be allowed to view and/or schedule the content.

With respect to publishing binge watching playlists, it is also possible that third parties are able to generate and publish playlists for other users to view. For example, a content source may wish to provide a binge watching playlist of popular content for the upcoming week that can be viewed during a span of time. In this way, the user can view all the popular shows during the past week from a single content source in a single binge watching session.

Other third parties may wish to provide a binge watching playlist of all available content associated with a particular series or season. For example, a binge watching playlist can include all episodes for the current season of a show for the user to view.

Furthermore, binge watching playlists may also be generated based on conditions or themes. For example, a playlist can be generated of the most popular scary movies that can be viewed on Halloween. Alternatively, a playlist of all movies in a franchise can be generated prior to the release of a sequel.

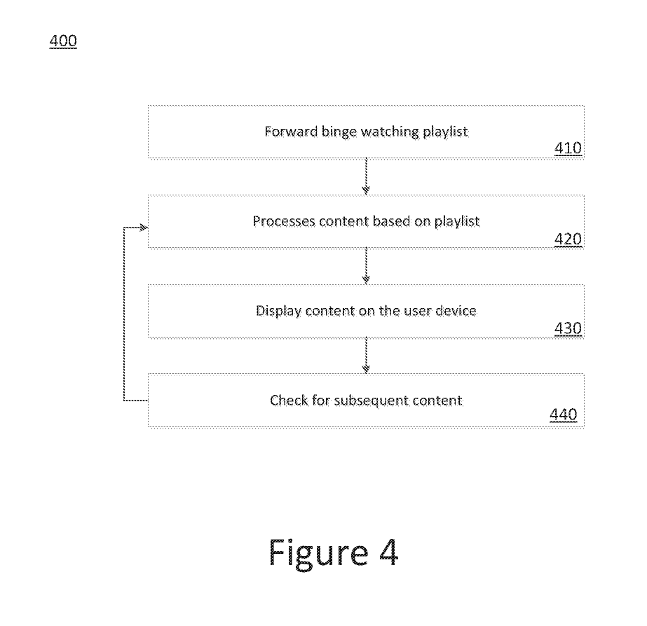

FIG. 4 illustrates a method 400 for providing content for the user to view based on the generated binge watching playlists. The generated binge watching playlist includes the scheduled list of content (e.g. live content and content on demand) that the user would like to view during a binge watching session.

In step 410, the generated binge watching playlist is transmitted to the Content Provider Server API of the binge watching playlist system illustrated, for example, in FIG. 1. As described above, the user device provides information regarding what the user would like to view to the Content Provider Server API via the binge watching playlist. By using the binge watching playlist, the Content Provider Server API can prepare the corresponding content to the Content Delivery Network beforehand so that it can subsequently be provided to the user a seamless manner based on the schedule outlined in the binge watching playlist.

In step 420, the Content Provider Server API processes the content based on the generated binge watching playlist so that the corresponding user device can receive and render the content for viewing on the user device. Following the binge watch playlist schedule, the Content Provider Server API retrieves and processes the content based on the schedule. If it is available, the live content from the content source can be forwarded to the Content Provider Server API (as illustrated in FIG. 1) so that it can be processed (i.e. encoded) for display on the user device.

If for some reason the live content on the generated binge watching playlist is not yet available (i.e. delayed release) yet was scheduled to be viewed by the user, the Content Provider Server API may inform such status to the user on the user device. The Content Provider Server API may subsequently attempt to request the next available live content on the binge watching playlist. If available, the Content Provider Server API may proceed with instructing the next available live content on the binge watching playlist to be provided to the user device.

Any unavailable live content may be rescheduled accordingly. For example, the binge watching playlist may be modified by the user device and/or the Content Provider Server API may reorder the currently unavailable live content to be played after a current live content. In other embodiments, the unavailable live content may be added to the end of the binge watching playlist.

During viewing of the currently available live content, the Content Provider Server API may periodically check in with the corresponding content sources to determine if the live content previously unavailable is now unavailable. If the previously unavailable content is confirmed to be now available, the now available live content can subsequently be provided to the user device after the current live content has completed. In other embodiments, the live content now available may be provided based on the amended binge watching playlist schedule (i.e. at the end).

In step 430, the requested content is provided to the client device. As noted above, the Content Provider Server API can transmit a request for the scheduled live content associated with the binge watching playlist to the associated content source. If available, the content source provides the requested live content to their Content Provider Server API so that the live content can be processed for the user device. Formatting may be performed so that the live content is compatible with the user device.

User access to the live content via the binge watch playlist system may be contingent on the user device being communicatively connected to the system for the duration of the binge watching session. For example, the binge watch playlist system may include security protocols implemented using security-related modules that require that the user device update user access authorization (i.e. keys) after a pre-determined period of time (i.e. every ten minutes). The user device update may be performed automatically on the user device via corresponding applications associated with the binge watching playlist system without user interaction. However, these automated updates may require that the user device be continually connected to the system. In situations where the user device becomes disconnected from the binge watching playlist system (i.e. Internet outage), the user device may be prevented from obtaining and displaying the live content for the user. This is because the live content being provided to the user device is provided from the corresponding content source in real-time (i.e. streaming).

In another embodiment, the requested live content can also be recorded and saved for future viewing. In some embodiments, download of live content may be stored on the user device or other storage mediums. However, there may be alternative or additional requirements associated with downloading content (e.g. live or on demand) compared to streaming the content from the content sources. Such embodiment may allow users to obtain the live content during a first period of time where connectivity with the binge watch playlist system is available and later view the live content when connectivity to the system is no longer available (e.g. plane trip, car ride).

In step 440, the next content on the generated binge watch playlist is automatically requested (if available). In other words, the Content Provider Server API will continue to provide successive content on the binge watch playlist to the user device for viewing without the need for the user to search for or request the next content. Content is provided in an easy and seamless manner without the user needing to search for, request, and retrieve content for viewing. This automated viewing of content in succession is continued until either the user ends the binge watching session, the binge watching session ends, or all content in the binge watching playlist have been viewed.

FIG. 5 is a guide 500 that users can use to generate their binge watching playlist. The guide 500 is a compilation of information associated with live content that the user may be interested in viewing. The guide 500 may provide the information in a table that lists the live content (i.e. Show A) arranged based on their respective content source (i.e. Channel A) and when the live content is first available (i.e. 8 PM).

The guide 500 illustrated in the figure corresponds to a particular day 510. In this case, the shows listed in the guide correspond to the date of Jan. 1, 2017. However, users are able to view the guide for live content on other days (if available) via a drop down menu 520 that lists other days. Selection of one of the dates in the drop down menu 520 would generate a new guide 500 that corresponds to that selected date. In many cases, this would include a different listing of live content than what was originally provided. Users would be able to select live content to schedule within their binge watching playlist from different days by navigating the guides 500 for the different days using the drop down menu 520 if desired.

The guide 500 may also include content on demand alongside the live content. Alternatively, a separate guide may be provided for the content on demand. Since the content on demand is already available, the format of the guide may be slightly altered. For example, the guide for content on demand may only list the content sources.

The guide 500 may also include additional information associated with the content. User selection of content may display additional information such as a an overview or summary of the content, synopsis of the specific content, ratings, run-time, and restrictions/credentials needed for viewing the content. Such information may be useful in providing some background information to help users decide whether they would like to place the live content on their binge watching playlist and when they may want to schedule the viewing.

When the user selects a particular content from the guide 500, via the user device, a prompt may be provided to the user. The prompt would include instructions that requests user input regarding whether the user would like to place the content on the binge watching playlist and/or when the user would like to view the selected content. If there are some existing content already schedule on the binge watching playlist, the prompt may request user input dictating when the selected content should be scheduled in comparison to the already scheduled content on the binge watching playlist.

The guide, as illustrated in FIG. 5, may correspond to live content. With respect to content on demand, lists of content (e.g. movie) may be provided to the user on their user device that would be usable to obtain information about available content on demand. Similar to the guides provided for live content, the lists would include the different content sources. However, since content on demand is already available, there is no need to provide or organize the content based on date/time. Instead, the content on demand may be organized via rating, genre, or series.

FIG. 6 is a binge watching playlist 600 generated using the guide of FIG. 5. Using the guide from FIG. 5, the binge watching playlist 600 illustrated in FIG. 6 shows an example schedule of content that the user will be viewing during a binge watching session starting at 8 PM-11:30 PM on January 9th. The live content scheduled using the binge watching guide will be requested using the binge watching playlist system and provided to the user device for viewing in an easy and seamless manner much like how the user can binge watch different episodes of the same show via DVD or streaming media. However, the live content scheduled for this binge watching session can be from different sources and/or different shows. Furthermore, the live content is provided in an automatic succession so that the user would not need to search for and request content individually.

The binge watching playlist 600 would correspond to a particular date 610. However, it may be possible that other playlists 600 on other dates can be viewed via a drop down menu option (not illustrated). Similar to the drop down menu for the guide in FIG. 5, the drop down menu for the binge watching playlist 600 would provide the list of content (live or on demand) that may be scheduled on that respective date in situations where the user has generated multiple binge watching playlists.

In an embodiment, a reoccurring update to the binge watching list can be generated on a pre-determined time interval if it consists of live content that is provided on a similar pre-determined time interval. For example, if the user includes a binge watching list that includes three programs that have new content on a weekly basis, the binge watching list can be updated to include those three same programs for the user for the following week as well. In this way, the user can stay on top of new live content automatically when it becomes available.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

1. A method for temporally generating content playlists, the method comprising:
receiving information regarding when a plurality of content titles associated with plurality of different content sources is available for viewing;
updating a database with the received information;
compiling an aggregated list of available content titles based on the updated database;
displaying the aggregated list of the available content titles;
receiving selections indicating a plurality of the content titles from the displayed list, the selection further indicating an order in which each indicated content title be scheduled for retrieval; and
generating a binge watching playlist based on the indicated content titles in the indicated order, wherein the indicated content titles in the binge watching playlist is automatically retrieved and provided from the plurality of content sources to a user device in a succession based on the indicated order during a binge watching session.

2. The method of claim 1, wherein the generated binge watching playlist includes a combination comprising a plurality of live content, content on demand, and third party video content from the plurality of content sources.

3. The method of claim 1, wherein the received information includes descriptive information specific to each of the [[live]] content titles.

4. The method of claim 3, further comprising initiating another display that provides the descriptive information specific to each of the content titles.

5. The method of claim 1, wherein the received information includes restrictions specific to each of the content titles.

6. The method of claim 5, wherein the restrictions include subscriptions and licenses associated with each of the content titles.

7. The method of claim 5, wherein the restrictions include blackouts that prevent a display of each of the content titles.

8. The method of claim 5, wherein the received information also includes information for lifting the restrictions on each of the content titles.

9. The method of claim 1, wherein at least one of the indicated content titles is a live content title, and further comprising receiving scheduling input for scheduling play of the live content title in relation to other content titles from the binge watching playlist.

10. The method of claim 1, wherein at least one of the indicated content titles is a live content title, and wherein the received information also includes suggestions of alternative content titles if the live content title is not available for automatic retrieval.

11. A method for temporally generating content playlists, the method comprising:
generating a binge watching playlist that includes a schedule of a plurality of content titles to be retrieved from a plurality of different content sources and played in succession at a user device during a pre-determined period of time designated as a binge watching session;
identifying a first content title on the binge watching playlist;
providing the first content title to a user device by retrieving the identified first live content title from a first content source;
identifying a second content title on the binge watching playlist, when play of the first content title is complete; and
providing automatically the second content title on the user device by retrieving the second content title from a second content source different from the first content source.

12. The method of claim 11, wherein the binge watching playlist further includes content on demand, live content, and third party video content from the plurality of different content sources.

13. The method of claim 11, wherein the binge watching playlist is sharable with at least one other user device.

14. The method of claim 11, wherein providing the first content title to the user device comprises streaming the first content title from the first content source to the user device over a network.

15. The method of claim 11, wherein providing the first content title to the user device comprises downloading the first content title from the first content source to the user device over a network.

16. The method of claim 11, further comprising modifying the binge watching playlist to reschedule when the first content title is played based on current unavailability of the first content title and availability of a second content title.

17. The method of claim 16, further comprising:
detecting when the first content title becomes available; and
rescheduling the first content title to be retrieved after play of a current content title has been completed.

18. A system for temporally generating content playlists, the system comprising:
a communication interface that receives information regarding when a plurality of content title associated with the plurality of different content sources is available for viewing,
memory that updates a database with the received information,
a processor that executes instructions stored in memory, wherein execution of the instructions by the processor:
compiles an aggregated list of available content titles based on the updated database,
generates a display of the aggregated list of the available content titles, wherein selections are received indicating a plurality of the content titles from the aggregated list, the selection further indicating an order in which each indicated content title be scheduled for retrieval,
generate a binge watching playlist based on the indicated content titles in the indicated order, wherein each of the indicated content titles in the binge watching playlist is automatically retrieved and provided from one of the content sources to a user device in a succession based on the indicated order during a binge watching session,
identify a first content title on the generated binge watching playlist at a start of a binge watching session,
provide the first content title on the user devices by retrieving the first content title from a first content source,
identify a second content title on the binge watching playlist when play of the first content title is complete, and
provide the second content title to the user device by retrieving the second content title from a second content source different from the first content source.

19. The method in claim 1, further comprising a chat interface that allows the user device to communicate with at least one other user device detected as playing a same content title.

20. A non-transitory computer-readable storage medium, having embodied thereon a program executable by a processor to perform a method for temporally generating content playlists, the method comprising:
receiving information regarding when a plurality of content titles associated with plurality of different content sources is available for viewing;
updating a database with the received information;
compiling an aggregated list of available content titles based on the updated database;
displaying the aggregated list of the available content titles;
receiving selections indicating a plurality of the content titles from the displayed list, the selection further indicating an order in which each indicated content title be scheduled for retrieval; and
generating a binge watching playlist based on the indicated content titles in the indicated order, wherein the indicated content titles in the binge watching playlist is automatically retrieved and provided from the plurality of content sources to a user device in a succession based on the indicated order during a binge watching session.
